(19) United States
(12) Patent Application Publication
(10) Pub. No.: US 2014/0272125 A1
(43) Pub. Date: Sep. 18, 2014

(54) ANTI-REFLECTION GLASS MADE FROM AGED SOL INCLUDING MIXTURE OF TRI-ALKOXYSILANE AND TETRA-ALKOXYSILANE

(71) Applicant: GUARDIAN INDUSTRIES CORP, Auburn Hills, MI (US)

(72) Inventors: Liang LIANG, Taylor, MI (US); Richard Blacker, Farmington Hills, MI (US); Nikhil D. Kalyankar, Mountain View, CA (US); Scott Jewhurst, Redwood City, CA (US)

(73) Assignee: Guardian Industries Corp, Auburn Hills, MI (US)

(21) Appl. No.: 13/826,011

(22) Filed: Mar. 14, 2013

(51) Int. Cl. C09D 5/00

(52) U.S. Cl. CPC C09D 5/006
USPC 427/161

(57) ABSTRACT

A method of making a coated article including an anti-reflection coating on a glass substrate, the method comprising: mixing at least a tri-alkoxysilane based binder and a tetra-alkoxysilane based binder with at least silica based nanoparticles and a solvent in forming a coating sol formulation; aging the coating sol formulation at least about two weeks so as to provide an aged coating sol formulation; coating at least a portion of said aged coating sol formulation onto the glass substrate to form a coating; and heating said glass substrate and said coating. Anti-reflection (AR) glasses show improved mechanical strength and higher transmittances (e.g., Tqe % gain).

Certain embodiments of this invention relate to antireflective (AR) coatings, and coated glass substrates having such AR coatings thereon, that provide low reflectivity and a higher percent of light transmission over a broad range of light wavelengths (e.g., including visible wavelengths) when used to manufacture semiconductor devices, solar cells, energy cells or other glass products. In particular, a new type of coating for use in pattern glass, such as matte-matte, matte-prismatic matte and solar float anti-reflection glass products is provided that can improve the mechanical strength of the glass while providing a high level of light transmission.

### BACKGROUND AND SUMMARY OF THE INVENTION

Coatings that provide low reflectivity and/or a high percent transmission over a broad wavelength range of light are desirable in many applications including solar cells, windows, and the like. Light transmission through material causes the wavelength of the light to change, a process known as refraction, while the frequency remains unchanged thus changing the speed of light in the material. Antireflective (AR) coatings are typically applied to the surface of a transparent substrate to reduce reflectance of visible light from the article and improve transmission of such light through the substrate.

Sol-gel based antireflective (AR) coatings using alkyltrialkoxysilane binders having low refractive index are described in U.S. Ser. No. 13/273,007, filed Oct. 13, 2011, the disclosure of which is hereby incorporated herein by reference. For example, the '007 application discloses coating a substrate with a sol-formulation comprising an alkyltrialkoxysilane-based binder having the formula (I):

[chemical structure]

where R₁, R₂, and R₃ are the same or different and each represents an alkyl group containing 1 to 20 carbon atoms, an aryl group containing 6 to 20 carbon atoms, or an aralkyl group containing 7 to 20 carbon atoms, wherein R₄ represents an alkyl group containing 1 to 20 carbon atoms, an aryl group containing 6 to 20 carbon atoms, an aralkyl group containing 7 to 20 carbon atoms, or a fluoro-modified alkyl group containing 1 to 20 carbon atoms, and silica based nanoparticles, wherein a mass ratio of the alkyltrialkoxysilane-based binder to the silica based nanoparticles is between 0.1:1 to 20:1. The sol-gel formulation also includes an alcohol containing solvent and an acid or base containing catalyst, in addition to the alkyltrialkoxysilane-based binder. After a glass substrate is coated with the sol gel, the coated glass substrate is annealed.

The term “binder” as used herein refers to a component used to bind together one or more types of materials in mixtures. The principal properties of a binder are adhesion and/or cohesion. The term “sol-formulation” as used herein is a chemical solution comprising at least a silane-inclusive and/or silane-based binder and silica inclusive and/or silica-based nanoparticles. The term “sol-gel process” as used herein is a process where a wet formulation (the “sol”) is dried to form a gel coating having both liquid and solid characteristics. The gel coating is then heat treated to form a solid material. This technique is valuable for the development of coatings because it is easy to implement and provides films of substantially uniform composition and thickness.

The AR coatings in the '007 application thus relate to a wet chemical film deposition process using a specific sol-formulation including a alkyltrialkoxysilane-based binder and silica based nanoparticles to produce porous anti-reflective coatings with a low refractive index (e.g., lower than glass). The sol-formulation in the '007 application may be prepared by mixing the alkyltrialkoxysilane-based binder, silica based nanoparticles, an acid or base containing catalyst, water, and a solvent system. The sol-formulation may be formed by at least one of a hydrolysis and polycondensation reaction. The sol-formulation may be stirred at room temperature or at an elevated temperature (e.g., 50-60 degrees Celsius) until the sol-formulation is substantially in equilibrium (e.g., for a period of 24 hours). The sol-formulation may then be cooled and additional solvents added to reduce the ash content if desired.

A transparent glass substrate is coated with the sol-formulation. The coating on the substrate is then dried to form a gel. A gel is a coating that has both liquid and solid characteristics and may exhibit an organized material structure. During the drying, solvent of the sol-formulation is evaporated and further bonds between the components, or precursor molecules, may be formed. The drying may be performed by exposing the coating on the substrate to the atmosphere at room temperature or a heated environment. The gel is then annealed to form the porous coating. E.g., the annealing temperature may be in the range of 300-1,000 degrees C.

Unfortunately, it has been found that the AR coating of the '007 application (described above) is lacking with respect to durability. Thus, it will be appreciated that there exists a need in the art for a more durable AR coating.

In certain example embodiments of this invention, there is provided a method of making a coated article including an anti-reflection coating on a glass substrate, the method comprising: mixing at least a tri-alkoxysilane based binder and a tetra-alkoxysilane based binder with at least silica based nanoparticles and a solvent in forming a coating sol formulation; aging the coating sol formulation at least about two weeks so as to provide an aged coating sol formulation; coating at least a portion of said aged coating sol formulation onto the glass substrate to form a coating; and heating said glass substrate and said coating. This technique results in a more durable coating than the coating of the '007 application. Aging the coating sol formulation (e.g., for at least two or three weeks) results in improved durability of the resulting product. During the aging of the coating sol solution, hydrolysis and condensation occur. The hydrolysis takes hours to occur whereas the condensation takes at least about two weeks to occur to a desirable extent. If the coating sol is aged less than ten days or less than two weeks, it has been found that the durability of the resulting is not as good compared to if aging for at least two or three weeks is allowed. Thus, the aging significantly improves the durability of the final product.

TEOS only sol formulation provides good durability but suffers from poor transmittance gain due to poor conformality (high variation in localized thickness and refractive index of the AR coating) on textured glass. It was surprisingly found that alkyltrialkoxysilane (e.g., CTMS like) binder based sol formulations lead to improved transmittance gain on textured glass due to improved coating conformality (substantial uniformity in localized thickness and refractive index of the AR coating on textured glass). Explanations for this phenomenon includes different wetting behavior of alkyltrialkoxysilane based sol formulations due to presence of the alkyl side chain attached to the central Si atom as well as impact of use of alkyltrialkoxysilane binder on the sol-gel transition during the coating process. And while alkyltrioalkoxysilane binder only formulations suffered from poor durability, alkyltrialkoxysilanes are mixed with tetraalkxysilanes according to example embodiments of this invention to balance the optical gain and durability. Combination of these two silanes leads to a more conformal coatings with higher transmittance gain and good durability.

In certain embodiment of this invention, there is provided a method of making a coated article including an anti-reflection coating on a substrate (e.g., glass or quartz substrate), the method comprising: mixing at least a first solution including a tri-alkoxysilane based binder with a second solution including a tetra-alkoxysilane based binder in forming a coating sol formulation; aging the coating sol formulation at least about ten days (more preferably at least about two weeks, and most preferably at least about three weeks) so as to provided an aged coating sol formulation; coating at least a portion of said aged coating sol formulation onto the glass substrate to form a coating; and curing the coating (e.g., by heating or the like).

### BRIEF DESCRIPTION OF THE DRAWINGS

FIG. 1 is a graphic depiction of the chemical reaction showing the hydrolysis of tetraethyl orthosilicate (TEOS) with acid as a catalyst;

FIG. 2 is a graphic depiction of the chemical reaction showing the hydrolysis of cyclohexyltrimethoxysilane (CTMS) with acid as a catalyst;

FIG. 3 is a graphic depiction of the electronic status of the silicone atoms in the cyclohexyltrimethoxysilane and tetraethyl orthosilicate;

FIG. 4 is a graphic depiction of the chemical reaction of the condensation of hydrolyzed tetraethyl orthosilicate with acid as a catalyst;

FIG. 5 is a graphic depiction of the chemical reaction of the condensation of hydrolyzed cyclohexyltrimethoxysilane with acid as a catalyst;

FIG. 6 is a percent transmission gain graph showing that mixed binder formulation according to an example of this invention leads to superior optical transmittance gain compared with the traditional single binder tetraalkoxysilane based formulation on glass;

FIG. 7 is a refractive index (n) vs. weight % of alkyltrialkoxysilane in mixed binder formulation showing that, in a mixed binder formulation according to an example embodiment of this invention, increasing the amount of alkyltrialkoxysilane leads to reduction in refractive index (n).

### DETAILED DESCRIPTION OF EXAMPLE EMBODIMENTS OF THE INVENTION

Certain embodiments of this invention relate to antireflective (AR) coatings, and coated glass substrates having such AR coatings thereon, that provide low reflectivity and a higher percent of light transmission over a broad range of light wavelengths (e.g., including visible wavelengths) in the resulting product when used to manufacture semiconductor devices, solar cells, energy cells or other glass products. The final product can be considered the coated glass article after the coating has been cured, and/or such a coated glass article in a device such as a semiconductor device, solar cell, energy cell, and/or other product. For example, a new type of coating for use in pattern glass, such as matte-matte, matte-prismatic matte and solar float anti-reflection glass products is provided that can improve the mechanical strength of the glass while providing a high level of light transmission.

In certain example embodiments of this invention, there is provided a method of making a coated article including an anti-reflection coating on a glass substrate, the method comprising: mixing at least a tri-alkoxysilane (tri) based binder and a tetra-alkoxysilane (tetra) based binder with at least silica based nanoparticles and a solvent in forming a coating sol formulation; aging the coating sol formulation at least about two weeks so as to provide an aged coating sol formulation; coating at least a portion of said aged coating sol formulation onto the glass substrate to form a coating; and heating said glass substrate and said coating. This technique results in a more durable coating than the coating of the '007 application. Aging the coating sol formulation (e.g., for at least two or three weeks) results in improved durability of the resulting product. During the aging of the coating sol solution, hydrolysis and condensation occur. The hydrolysis takes hours to occur whereas the condensation takes at least about two weeks to occur to a desirable extent. If the coating sol is aged less than two weeks, it has been found that the durability of the resulting is not as good compared to if aging for at least two or three weeks is allowed. For example, absent significant aging, the coating of the coated article has been found to have a refractive index (n) of about 1.24 but the coated article does not pass the Crockmeter test (i.e., bad mechanical durability). On the other hand, when the coating sol is aged for at least about two or three weeks, the coating of the coated article has been found to have a refractive index (n, with all refractive index values herein measured at 550 nm) of from about 1.27 to 1.28 and the coated article has been found to pass the Crockmeter test which evidences improved durability. Thus, the aging alters the refractive index and allows the coated article to pass the Crockmeter test which evidences improved mechanical durability of the final product. Anti-reflection glass using a sol coating of or including a mixture of tri-alkoxysilane and tetra-alkoxysilane can result in a coated article having improved physical properties and ultimately provide an improved anti-reflective glass product with high levels of light transmittance.

TEOS only sol formulation provides good durability but suffers from poor transmittance gain due to poor conformality (high variation in localized thickness and refractive index of the AR coating) on textured glass. It was surprisingly found that alkyltrialkoxysilane (e.g., CTMS like) binder based sol formulations lead to improved transmittance gain on textured glass due to improved coating conformality (substantial uniformity in localized thickness and refractive index of the AR coating on textured glass). Explanations for this phenomenon includes different wetting behavior of alkyltrialkoxysilane based sol formulations due to presence of the alkyl side chain attached to the central Si atom as well as impact of use of alkyltrialkoxysilane binder on the sol-gel transition during the coating process. And while alkyltrioalkoxysilane binder only formulations suffered from poor durability, alkyltrialkoxysilanes are mixed with tetraalkxysilanes according to example embodiments of this invention to balance the optical gain and durability. Combination of these two silanes leads to a more conformal coatings with higher transmittance gain and good durability.

The coating sol formulation, prior to curing, may comprise silica based nanoparticles, wherein a mass ratio of the tri-alkoxysilane based binder and tetra-alkoxysilane based binder to the silica based nanoparticles in the coating sol formulation may be from 0, 1:1 to 20:1. The silica based nanoparticles in the coating sol formulation may have a shape selected from spherical, elongated, disc-shaped, and combinations thereof. Silica based nanoparticles in the coating sol may be selected from spherical particles having a particle size from about 40 to 50 nm, spherical particles having a particle size from about 70 to 100 nm, spherical particles having a particle size from about 10 to 15 nm, spherical particles having a particle size from about 17 to 23 nm, elongated particles having a diameter from 9 to 15 nm and length of 40 to 100 nm, and combinations thereof.

The coating sol formulation may further comprise an alcohol containing solvent (e.g., NPA), and an acid or base containing catalyst, in certain example embodiments. For example, the coating sol formulation may also include water, acetic acid and n-propyl alcohol (NPA).

The tri-alkoxysilane based binder may comprise from about 10 wt. % to about 80 wt. % ash contribution in the total ash content of the coating sol formulation in certain example embodiments.

The glass substrate may be matte-matte glass, and/or the glass substrate may be soda-lime-silica based float glass. The coating step may comprise spin coating, dip coating, curtain coating, spray coating, or the like in applying the coating sol formulation on (directly or indirectly) the substrate.

The tri-alkoxysilane based binder may be selected from the group consisting of n-propyltriethoxysilane, n-pentyltriethoxysilane, n-hexyltriethoxysilane, cyclohexyltrimethoxysilane, and combinations thereof. For example, the tri-alkoxysilane based binder may comprise or consists essentially of cyclohexyltrimethoxysilane (CTMS) in certain example embodiments. The alkyltrialkoxysilane-based binder may be represented by the general formula (I) shown herein in the background section. Exemplary alkyl groups containing 1 to 20 carbon atoms may be selected from the group consisting of n-butyl, isobutyl, n-pentyl, isopentyl, n-hexyl, isohexyl, cyclohexyl, n-heptyl, methoylcyclohexyl, octyl, ethylcyclohexyl, and the like. Exemplary aryl groups containing 6 to 20 carbon atoms may be selected from the group consisting of: phenyl, benzyl, xylyl, and the like. Exemplary fluoro-modified alkyl groups containing 1 to 20 carbon atoms may be selected from the group consisting of: fluoromethyl, fluoroethyl, fluorohexyl, and the like. Exemplary alkyltrialkoxysilane-based binders may be selected from the group consisting of n-propyltriethoxysilane, n-pentyltriethoxysilane, n-hexyltriethoxysilane, cyclohexyltrimethoxysilane (CTMS), methyltriethoxysilane (MTES), methyltrimethoxysilane (MTMS), glycidoxipropyltrimethoxysilane (Glymo), N-butyltrimethoxysilane, aminoethyltrimethoxysiiane, trimethoxysilane, triethoxysilane, vinyltrimethoxysilane, propyltriethoxysilane (PTES), ethyltriethoxysilanc (ETES), n-butyltriethoxysilane (BTES), methylpropoxysilane, and combinations thereof.

The tetra-alkoxysilane based binder may comprise or consist essentially of TEOS in certain example embodiments. Example tetra-alkoxysilane based binders which may be used may be selected from the group consisting of: tetraethyl orthosilicate or tetraethoxysilane (TEOS), tetramethoxysilane, tetra-n-propoxysilane, tetra-i-propoxysilane, tetra-n-butoxysilane, tetra-t-butoxysilane, and combinations thereof.

In the coating sol formulation, the amount of tetra-alkoxysilane based binder may be from about 15-80% (wt. %) (more preferably from about 20-70%, and most preferably from about 40-60%) of the combination of the tetra-alkoxysilane based binder and the tri-alkoxysilane based binder.

The thickness of the coating on the substrate, after curing, may be from about 100 to 180 nm, more preferably from about 120 to 140 nm, in certain example embodiments. A refractive index (n) of the coating following curing may be from about 1.25 to 1.30, more preferably from about 1.27 to 1.29. The heating used for curing the coating may include heating the coated glass substrate at temperature(s) of at least about 580 degrees C. for at least about 1 minute. The alkyltrialkoxysilane may act as a porogen after the thermal process.

Visible transmittance may be increased by at least about 2.8% as a result of the coating being applied and cured (e.g., via heating) on the substrate, compared to a situation where the coating is not applied on the substrate.

For example, the coating sol formulation may include from about 1 wt. % to about 50 wt. % (more preferably from about 3 to 50%) of alkyltrialkoxysilane-based and tetra-alkoxysilane based binders; from about 0.1 wt. % to about 15 wt. % of silica-based nanoparticles; from about 50 wt. % to about 95 wt. % of an alcohol containing solvent(s); and from about 0.001 wt. % to about 2 wt. % of an acid or base containing catalyst. For example, the alcohol containing solvent may be of or include n-propyl alcohol (NPA), and the acid or base containing catalyst may be of or include acetic acid and/or nitric acid. The silica based nanoparticles may be spherical or non-spherical (e.g., elongated, pearl-shaped, or disc-shaped), such as silica based nanoparticles with at least one dimension between 10 and 200 nm. The silica based nanoparticles may be selected from spherical particles having a particle size from about 40 to 50 nm, spherical particles having a particle size from about 70 to 100 nm, spherical particles having a particle size from about 10 to 15 nm, spherical particles having a particle size from about 17 to 23 nm, elongated particles having a diameter from 9 to 15 nm and length of 40 to 100 nm, and combinations thereof. The silica based nanoparticles may be colloidal silica mono-dispersed in an organic solvent. Exemplary organic solvents include N,N-Dimethyl acetamide, ethylene glycol, isopropanol (IPA), methanol, methyl ethyl ketone, methyl isobutyl ketone, and methanol. The amount of silica based nanoparticles present in the organic solvent (which are then mixed in to help form the coating sol solution) may comprise between from about 15 wt. % and 45 wt. % of the total colloidal silica in organic solvent system. The colloidal silica in organic solvent system may comprise less than 3.0% water. The colloidal silica in organic solvent may have a viscosity less than 100 mPa·s, and/or a pH from about 2 to 6. Water-based silica nanoparticles can also be used, with the size of silica nanoparticles ranging from about 10-100 nm at a weight percentage of from about 18-40%. The amount of solid SiO₂ may be from about 2-6 wt % in the sol formulation. However, the solid percentage can be from 0.6-10 wt. %, with the amount of solvent comprising from about 60-97 wt. % in certain example instances.

Exemplary silica based nanoparticles are available from Nissan Chemical America Corporation under the tradename ORGANOSILICASOL™. Suitable commercially available products of that type include ORGANOSILICASOL™ IPA-ST silica particles (particle size of 10-15 nm, 30-31 wt. % of SiO₂), ORGANOSILICASOL™ IPA-ST-L silica particles (particle size of 40-50 nm, 30-31 wt. % of SiO₂), ORGANOSILICASOL™ IPA-ST-MS silica particles (particle size of 17-23 nm, 30-31 wt. % of SiO₂), ORGANOSILICASOL™ IPA-UP-ST silica particles (particles have a diameter of 9-15 nm with a length of 40-100 nm, 15-16 wt. % of SiO₂), and ORGANOSILICASOL™ IPA-ST-ZL silica particles (particle size of 70-100 nm, 30-31 wt, % of SiO2). Other exemplary silica based nanoparticles are available from Nissan Chemical America Corporation under the tradename SNOWTEX® colloidal silica. Suitable commercially available products of that type include SNOWTEX® ST-20L colloidal silica (particle size of 40-50 nm, 20-21 wt. % of SiO₂), SNOWTEX® ST-40 colloidal silica (particle size of 10-20 nm, 40-41 wt. % of SiO₂), SNOWTEX® ST-50 colloidal silica (particle size of 20-30 nm, 47-49 wt. % of SiO₂), SNOWTEX® ST-C colloidal silica (particle size of 10-20 nm, 20-21 wt. % of SiO₂), SNOWTEX® ST-N colloidal silica (particle size of 10-20 nm, 20-21 wt. % of SiO₂), SNOWTEX® ST-O colloidal silica (particle size of 10-20 nm; 20-21 wt. % of SiO₂), SNOWTEX® ST-OL colloidal silica (particle size of 40-50 nm, 20-21 wt. % of SiO₂), SNOWTEX® ST-ZL colloidal silica (particle size of 70-100 nm, 40-41 wt. % of SiO₂), SNOWTEX® ST-PS-M colloidal silica (particle size of 18-25 nm/80-150 nm, <0.2 wt. % of SiO₂), SNOWTEX® ST-PS-MO colloidal silica (particle size of 18-25 nm/80-150 nm, 18-19 wt. % of SiO₂), SNOWTEX® ST-PS-S colloidal silica (particle size of 10-15 nm/80-120 nm, 15-16 wt. % of SiO₂), SNOWTEX® ST-PS-O colloidal silica (particle size of 10-15 nm/80-120 nm, 15-16 wt. % of SiO₂), SNOWTEX® ST-OUP colloidal silica (particle size of 9-15 nm/40-100, 15-16 wt. % of SiO₂), and SNOWTEX® ST-UP colloidal silica (particle size of 9-15 nm/40-100 nm, <0.2 wt. % of SiO₂). The amount of silica based nanoparticles in the coating sol formulation may be at least 0.01 wt. %, 0.05 wt. %, 1 wt. %, 1.5 wt. %, 2 wt. %, 2.5 wt. %, 3 wt. %, 3.5 wt. %, 5 wt. %, 7 wt. %, 9 wt. %, 11 wt. %, or 13 wt. % of the total weight of the coating sol formulation. The amount of silica based nanoparticles in the coating sol formulation may comprise up to 0.05 wt. %, 1 wt. %, 1.5 wt. %, 2 wt. %, 2.5 wt. %, 3 wt. %, 3.5 wt. %, 5 wt. %, 7 wt. %, 9 wt. %, 11 wt. %, 13 wt. %, or 15 wt. % of the total weight of the coating sol formulation. The amount of the silica based nanoparticles in the coating sol formulation may be present in an amount between about 0.01 wt. % and about 15 wt. % of the total weight of the coating sol formulation. A mass ratio of the alkyltrialkoxysilane-based and tetra-alkoxysilane based binders to silica based nanoparticles may be between 60:40 and 90:10 in the coating sol formulation. It is noted that the coating sol formulation may further include rare-earth-based oxide nanoparticles.

As mentioned above, the coating sol formulation may include an acid or base catalyst for controlling the rates of hydrolysis and condensation. The acid or base catalyst may be an inorganic or organic acid or base catalyst. Exemplary acid catalysts may be selected from the group consisting of hydrochloric acid (HCl), nitric acid (HNO₃), sulfuric acid (H₂SO₄), acetic acid (e.g., AcOH and/or CH₃COOH), phosphoric acid (H₃PO₄), citric acid, and combinations thereof. Exemplary base catalysts include tetramethylammonium hydroxide (TMAH), sodium hydroxide (NaOH), potassium hydroxide (KOH, and the like. The acid catalyst level may be 0.001 to 10 times in stoichiometric amount compared with the combination of the alkyltrialkoxysilane-based and tetra-alkoxysilane based binders. The acid and/or base catalyst level may be from 0.001 wt. % to 1 wt. % of the total weight of the coating sol formulation.

The coating sol formulation may further include a solvent system. The solvent system may include a non-polar solvent, a polar aprotic solvent, a polar protic solvent, and/or combinations thereof. Selection of the solvent system and the porosity forming agent may be used to influence the formation and size of pores. Exemplary solvents include alcohols, for example, n-butanol, isopropanol, n-propanol, ethanol, methanol, and other well known alcohols. The amount of solvent in the coating sol formulation may comprise at least 50 wt. %, 55 wt. %, 60 wt. %, 65 wt. %, 70 wt. %, 75 wt. %, 80 wt. %, 85 wt. %, or 90 wt. % of the total weight of the coating sol formulation. The amount of solvent in the coating sol formulation may comprise up to 55 wt. %, 60 wt. %, 65 wt. %, 70 wt. %, 75 wt. %, 80 wt. %, 85 wt. %, 90 wt. %, or 95 wt. % of the total weight of the coating sol formulation. The amount of solvent may be from 50 wt. % to 95 wt. % of the total weight of the coating sol formulation. The solvent system may further include water (e.g., from about 0.5 to 7% wt. %, more preferably from about 1-3 wt. % of the coating sol formulation) and/or a surfactant for stabilizing the sol-gel composition.

Examples of making the coating sol formulation are set forth below in connection with Table 1, where sols are provided with two silanes (a tri and a tetra) mixed directly in the second, third and fourth coating sol formulations (the first and fifth sol formulations had one or the other of the silanes, but not both). Table 1 below shows the compositions of a series of different sols with the amount of tetra varied as shown in order to produce the different mixed silanes.

TABLE 1

| | tetra wt. % in the mixed silanes | | | | |
|---|---|---|---|---|---|
| Chem. ml | 0 | 20 | 50 | 70 | 100 |
| alkyltrialkoxysilane | 3.93 | 3.144 | 1.965 | 1.179 | 0 |
| tetra-alkoxysilane | 0 | 0.786 | 1.965 | 2.751 | 3.93 |
| IPA-UP-ST (~15 wt. % | 16.33 | 16.33 | 16.33 | 16.33 | 16.33 |
| silica nanoparticles in | | | | | |
| isopropyl alcohol) | | | | | |
| AcOH 10 wt. % in | 10.32 | 10.32 | 10.32 | 10.32 | 10.32 |
| n-propyl alcohol | | | | | |
| De-ionized water | 1.98 | 1.98 | 1.98 | 1.98 | 1.98 |
| NPA | 67.47 | 67.47 | 67.47 | 67.47 | 67.47 |
| Total | 100.03 | 100.03 | 100.03 | 100.03 | 100.03 |
| Diluted n-propyl alcohol, | 84.92 | 84.92 | 84.92 | 84.92 | 84.92 |
| ml after 24 hours* | | | | | |

*The sols may be further diluted by n-propyl alcohol after stirring at room temperature for 24 hours. The final solid percentage was about 3 wt. %.

By way of example, the following procedure was used to prepare the third coating sol formulation from Table 1, where equal amounts of the tri-alkoxysilane based binder and the tetra-alkoxysilane based binder were mixed in making the coating sol solution. 67.47 ml of n-propyl alcohol (NPA) was added to a 200 ml glass bottle equipped with a magnetic stirrer bar. 1.965 ml of the tri and 1.965 ml of tetra were added to the solution, followed by 16.33 ml of IPA-UP-ST and 1.98 ml of de-ionized water. 10.32 ml of AcOH (10 wt. % in n-propyl alcohol) was then added to the mixture at room temperature and the sol stirred. In Table 1, the sols may optionally be further diluted by NPA after stirring so as to provide sols with a solids content of about 3 wt. %.

Aging the coating sol formulations like the second, third and fourth examples from Table 1 above (ordered moving from the left of the table, thus the examples with 20, 50 and 70% tetra respectively) results in improved durability of the resulting product. During the aging of the coating sol solution, hydrolysis and condensation occur. The hydrolysis takes hours to occur whereas the condensation takes at least about ten days or at least about two weeks to occur to a desirable extent. An example of aging is at approximately room and/or ambient temperature in a plastic sealed drum. It is preferred that the coating sol is aged at least about 10 days, more preferably at least about two weeks, and even more preferably at least about three weeks (e.g., at approximately room and/or ambient temperature). If the coating sol is aged less than this, it has been found that the durability of the resulting is not as good compared to if aging for at least two or three weeks is allowed. For example, absent significant aging, the coating of the coated article has been found to have a refractive index (n) of about 1.24 but the coated article does not pass the Crockmeter test (i.e., bad mechanical durability). On the other hand, when the coating sol is aged for at least about 10 days, two weeks, or three weeks, the coating of the coated article has been found to have a refractive index (n, with all refractive index values herein measured at 550 nm) of from about 1.27 to 1.28 and the coated article has been found to pass the Crockmeter test which evidences improved durability. Thus, the aging has surprisingly been found to alter the refractive index and to allow the coated article to pass the Crockmeter test which evidences improved mechanical durability of the final product.

Visible transmittance can be increased by at least about 2.5% or 2.8% as a result of said coating being applied on (directly or indirectly) the glass substrate, more preferably by at least about 3%. As a general proposition, the transmission of light through a material causes the wavelength of the light to change as the frequency remains unchanged, thus slightly altering the speed of light through the material. The refractive index of a material is a measure of the speed of light through a substance and generally is expressed as the ratio of the speed of light in vacuum relative to the speed of light in the material. Low reflectivity coatings typically have an optimized refractive index (n) that falls between air (where n=1) and glass (n˜1.5). An anti-reflective coating is a type of low reflectivity coating applied to the surface of a transparent article (e.g., glass) in order to reduce the reflectance of visible light from the article and enhance the transmission of light into and through the article with a resulting decrease in the refractive index.

Certain embodiments of this invention relate to sol-gel processes and sol formulations used to produce low refractive index coatings on glass substrates. The term sol-gel process is a process where a wet formulation forms a gel coating having both liquid and solid characteristics on a glass substrate and is then heat treated to form a final solid coating. Sol gel processes have proven to be valuable for developing new anti-reflective glass coatings because of their ability to produce very thin films having uniform compositions and precise thicknesses. Tests performed on anti-reflection glasses indicate that the overall mechanical strength of the anti-reflection (AR) thin film and the level of adhesion of the thin film to the glass substrate can be improved by the blending and aging processes described herein which is performed prior to coating onto the substrate. Thus, it is desirable to improve the mechanical strength and adhesive qualities of anti-reflection films made by a sol gel process while at the same time improving the light transmittance of the final product.

A method for improving the mechanical strength of AR thin film of anti-reflection glass has been found by mixing the trialkoxy and tetraalkoxy binders in forming a coating sol formulation prior to coating the resulting sol onto a glass substrate. AR glass made by using tetraethyl orthosilicate (TEOS) alone as a binder have demonstrated good mechanical strength and good optical performance. Although the hydrolysis rate of CTMS used as a binder is higher than that of TEOS with acidic hydrolysis, the condensation rate of CTMS is lower than that of TEOS. Thus, when used as a sol component, it has been found that the lower condensation rate and few potential crosslinking groups of CTMS can result in incomplete reaction of the binder with the silica nanoparticles and glass surface and hence a lower crosslinking density, at times resulting in thin films with weaker mechanical strength and poor adhesion with the glass surface. It has been found that the durability of matte-matte and solar float anti-reflection glass can be significantly improved through the use of sol coatings made by mixing the TEOS and CTMS binders in forming a coating sol formulation, and aging the sol formulation as discussed herein prior to coating on the substrate. AR glass products with improved mechanical strength can then be prepared by spin coating or dip coating the blended coating sol formulation onto the surface of the glass substrate and curing the coated glass in an oven (e.g., from about 580-800 degrees C., e.g., about 650° C., for about from 10-12 minutes, e.g., about 3.5 minutes). A higher transmittance of broadband (Tqe % gain) can also be achieved using anti-reflection glass made from the mixed tri-alkoxysilane and tetra-alkoxysilane binders.

Note that the Crockmeter test uses a glass size of 3″×3″ and with a total test cycle of 500. The failure specification of the Crockmeter test is ΔTqe %>=1.5%.

FIGS. 1 and 2 below show the hydrolysis of tetraethyl orthosilicate and cyclohexyltrimethoxysilane, respectively, with acid as the catalyst. The following mechanisms generally describe the hydrolysis of tetraethyl orthosilicate and cyclohexyltrimethoxysilane. First, the electrophilicity of the Si atom is enhanced by the attack of a proton on the OR group in the tetraethyl orthosilicate or cyclohexyltrimethoxysilane. The proton is released from the acetic acid. The Si atom (which has greater electrophilicity) is easily attacked by a water molecule and an intermediate is therefore generated as shown in FIGS. 1 and 2. The further reaction of the intermediate produces the hydrolyzed tetraethyl orthosilicate or cyclohexyltrimethoxysilane and releases a proton, H⁺, which is again used as the catalyst.

The process is reversible and can be repeated to generate various forms of hydrolyzed tetraethyl orthosilicate, for example silicic acid Si(OH)₄ as fully hydrolyzed tetraethyl orthosilicate. An esterification may also take place during the process. It has been found that the hydrolysis rate of cyclohexyltrimethoxysilane is faster than that of tetraethyl orthosilicate because of the cyclohexyl group having the characteristics of an electron donor (sec FIG. 3) that increases the electrophilicity of the OR group and render it vulnerable to attack by a proton.

The hydrolyzed tetraethyl orthosilicate and cyclohexyltrimethoxysilane can be further condensed by a water and alcohol condensation as shown in FIGS. 4 and 5, which depicts the reversible reactions of hydrolysis and alcoholysis, respectively (note also that cyclohexyl groups may be more likely to be in trans arrangement than the cis due to steric effects). The proton attacks oxygen atom in the hydroxyl group of the hydrolyzed alkoxysilane, which in turn increases the electrophilicity of Si atom that can be attacked by a hydroxyl group from a hydrolyzed alkoxysilane molecule. A water molecule is released from the intermediate and H₃O⁺ is generated by the water and proton. The cyclohexyl group in cyclohexyltrimethoxysilane works as an electron donor increasing the basicity of the Si atom which decreases the overall condensation rate. Conversely, the CH₃CH₂ group in tetraethyl orthosilicate increases the acidity of Si atom, which in turn increases the condensation rate. The steric effect of the cyclohexyl group reduces the condensation rate of the cyclohexyltrimethoxysilane.

Various hydrolyzed tetraethyl orthosilicate and cyclohexyltrimethoxysilane groups can be condensed to develop cyclic siloxane with different cyclic numbers, such as tetra-cyclic siloxane. Because of the reduced stability of tri-siloxane compounds, applicants believe that primary cyclic siloxane is generated from tetramer due to less strain on the cyclic compound. The cyclic siloxane reacts with other cyclic siloxane or hydrolyzed tetraethyl orthosilicate or cyclohexyltrimethoxysilane to produce an amorphous SiO₂ oligomer having the structure of a continuous random network. The results from a Si-NMR analysis support a mechanism whereby the condensation takes places in a manner that maximizes the number of Si—O—Si bonds and minimizes the number of terminal hydroxyl groups due to internal condensation. The three-dimensional oligomers serve as nuclei, and thus further growth occurs by the Ostwald ripening mechanism. That is, the oligomers grow in size and decrease in number as highly soluble small oligomers dissolve and re-precipitate on larger and less soluble nuclei. The growth stops when the difference in solubility between the smallest and largest oligomers become only a few ppm. Normally, the oligomers stop growing when they reach the size as 2-4 nm in a precursor solution having a pH of between 2-7, creating a sol.

The faster condensation in sols with tetraethyl orthosilicate has been found to result in a three dimensional network having a higher crosslinked density. The network with higher crosslinking density will have a higher mechanical strength. The probability of chemical covalent bonding between the glass surface and the thin film also increases when tetraethyl orthosilicate is used as the binder due to a somewhat faster condensation rate, greater number of crosslinkable groups and less steric or hydrophobic hindrance.

The pore size and porosity of the thin film on anti-reflection glass made from sol with larger amounts of tetraethyl orthosilicate will be lower than those of anti-reflection glass from sol of pure cyclohexyltrimethoxysilane as the binder. That may explain why the refractive index of anti-reflection thin film from pure cyclohexyltrimethoxysilane is less than that of pure tetraethyl orthosilicate. Anti-reflection thin films with a large pore size and porosity may exhibit weaker mechanical strength.

FIG. 6 illustrates data from trials according to examples of this invention, using a mixed binder formulation. FIG. 6 shows that mixed binder formulation leads to superior optical transmittance gain compared with the traditional single binder tetraalkoxysilane based formulation on textured glass. This result is explained by coating conformality. Accordingly, FIG. 6 shows that transmittance gain is improved using mixed binder formulations when compared with traditional tetraalkoxysilane binder only formulations, which is a surprising and unexpected result.

It has also been found that tetraalkoxysilane binder only formulation is less conformal compared to mixed binder according to example embodiments of this invention. Data indicates that there is less localized variation in refractive index and thickness for the mixed binder based formulations based AR coatings compared with the traditional tetraalkoxysilane binder only formulation based AR coatings.

FIG. 7 shows that, in a mixed binder formulation according to an example embodiment of this invention, increasing the amount of alkyltrialkoxysilane leads to reduction in refractive index (n) (or increase in porosity). The increased porosity is due to two effects, namely steric effect of the alkyl group attached to Si atom that leads to increased ‘openness’ in the oligomer network, and porogen effect of the alkyl side chain during the heat treatment (combustion of the organic side chain) leading to additional porosity. Accordingly, example embodiments of this invention provide an ability to tune porosity by using different levels of alkyltrialkoxysilane & tetraalkoxysilane combination. This has implications on RI as well as coating durability. The data is for a 10 day old formulation.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

In certain example embodiments of this invention, there is provided a method of making a coated article including an anti-reflection coating on a glass substrate, the method comprising: mixing at least a tri-alkoxysilane based binder and a tetra-alkoxysilane based binder with at least silica based nanoparticles and a solvent in forming a coating sol formulation; aging the coating sol formulation at least about two weeks so as to provide an aged coating sol formulation; coating at least a portion of said aged coating sol formulation onto the glass substrate to form a coating; and heating said glass substrate and said coating.

The method of the immediately preceding paragraph may comprise curing the coating via at least said heating.

In the method of any of the preceding two paragraphs, a mass ratio of a combination of the tri-alkoxysilane based binder and tetra-alkoxysilane based binder, to the silica based nanoparticles, in the coating sol formulation may be from 0.1:1 to 20:1.

In the method of any of the preceding three paragraphs, the tri-alkoxysilane based binder may comprise from about 10 wt. % to about 80 wt. % ash contribution in the total ash content of the coating sol formulation.

In the method of any of the preceding four paragraphs, the tri-alkoxysilane based binder may be selected from the group consisting of n-propyltriethoxysilane, n-pentyltriethoxysilane, n-hexyltriethoxysilane, cyclohexyltrimethoxysilane, and combinations thereof.

In the method of any of the preceding five paragraphs, the tri-alkoxysilane based binder may comprise cyclohexyltrimethoxysilane.

The method of any of the preceding six paragraphs may comprise forming a gel on the glass substrate by drying the aged coating sol formulation coated on the glass substrate prior to annealing the coated glass substrate.

In the method of any of the preceding seven paragraphs, silica based nanoparticles in the coating sol formulation may have a shape selected from spherical, elongated, disc-shaped, and combinations thereof.

In the method of any of the preceding eight paragraphs, silica based nanoparticles in the coating sol may be selected from spherical particles having a particle size from about 40 to 50 nm, spherical particles having a particle size from about 70 to 100 nm, spherical particles having a particle size from about 10 to 15 nm, spherical particles having a particle size from about 17 to 23 nm, elongated particles having a diameter from 9 to 15 nm and length of 40 to 100 nm, and combinations thereof.

In the method of any of the preceding nine paragraphs, the solvent may comprise an alcohol containing solvent (e.g., NPA), and/or the coating sol formulation may further include an acid or base containing catalyst.

In the method of any of the preceding ten paragraphs, in the coating sol formulation the amount of tetra-alkoxysilane based binder may be from about 15-80% (wt. %) (more preferably from about 20-70%, and most preferably from about 40-60%) of the combination of the tetra-alkoxysilane based binder and the tri-alkoxysilane based binder.

In the method of any of the preceding eleven paragraphs, said glass substrate may be a matte-matte glass.

In the method of any of the preceding twelve paragraphs, said glass substrate may be a soda-lime-silica based float glass.

In the method of any of the preceding thirteen paragraphs, said coating step may comprise spin coating, dip coating, spray coating, roll coating, curtain coating, or slot die coating.

In the method of any of the preceding fourteen paragraphs, visible transmittance may be increased by at least about 2.8% as a result of said coating being applied and cured on the glass substrate.

In the method of any of the preceding fifteen paragraphs, the thickness of said coating after curing may be from about 120 to 140 nm.

In the method of any of the preceding sixteen paragraphs, a refractive index of said coating following curing may be from about 1.25 to 1.30.

In the method of any of the preceding seventeen paragraphs, said heating may comprise heating the coated glass substrate at temperature(s) of at least about 580 degrees C. for at least about 1 minute.

In the method of any of the preceding eighteen paragraphs, the coating sol formulation may include water, acetic acid and n-propyl alcohol.

In the method of any of the preceding nineteen paragraphs, said aging may comprise aging the coating sol formulation at least about three weeks so as to provided the aged coating sol formulation.

In the method of any of the preceding twenty paragraphs, said coating sol formulation may comprise colloidal silica in at least one solvent.

In the method of any of the preceding twenty-one paragraphs, the tetra-alkoxysilane based binder may comprise TEOS.

In the method of any of the preceding twenty-two paragraphs, the coating may be applied directly or indirectly on the glass substrate.

In the method of any of the preceding twenty-three paragraphs, the alkyltrialkoxysilane-based hinder may comprise:

[chemical structure]

wherein R₁, R₂, and R₃ are the same or different and each represents an alkyl group containing 1 to 20 carbon atoms, an aryl group containing 6 to 20 carbon atoms, or an aralkyl group containing 7 to 20 carbon atoms; wherein R₄ represents an alkyl group containing 1 to 20 carbon atoms, an aryl group containing 6 to 20 carbon atoms, an aralkyl group containing 7 to 20 carbon atoms, or a fluoro-modified alkyl group containing 1 to 20 carbon atoms.

1. A method of making a coated article including an anti-reflection coating on a glass substrate, the method comprising:
mixing at least a tri-alkoxysilane based binder and a tetra-alkoxysilane based binder with at least silica based nanoparticles and a solvent in forming a coating sol formulation;
aging the coating sol formulation at least about two weeks so as to provide an aged coating sol formulation;
coating at least a portion of said aged coating sol formulation onto the glass substrate to form a coating; and
heating said glass substrate and said coating.

2. A method according to claim 1, comprising curing the coating via at least said heating.

3. A method according to claim 1, wherein the alkyltrialkoxysilane-based binder comprises: [chemical structure]
wherein R₁, R₂, and R₃ are the same or different and each represents an alkyl group containing 1 to 20 carbon atoms, an aryl group containing 6 to 20 carbon atoms, or an aralkyl group containing 7 to 20 carbon atoms;
wherein R₄ represents an alkyl group containing 1 to 20 carbon atoms, an aryl group containing 6 to 20 carbon atoms, an aralkyl group containing 7 to 20 carbon atoms, or a fluoro-modified alkyl group containing 1 to 20 carbon atoms.

4. A method according to claim 1, wherein a mass ratio of the tri-alkoxysilane based binder and tetra-alkoxysilane based binder to the silica based nanoparticles in the coating sol formulation is from 0.1:1 to 20:1.

5. The method of claim 1, wherein the tri-alkoxysilane based binder comprises from about 10 wt. % to about 80 wt. % ash contribution in the total ash content of the coating formulation.

6. The method of claim 1, wherein the tri-alkoxysilane based binder is selected from the group consisting of n-propyltriethoxysilane, n-pentyltriethoxysilane, n-hexyltriethoxysilane, cyclohexyltrimethoxysilane, and combinations thereof.

7. The method of claim 1, wherein the tri-alkoxysilane based binder comprises cyclohexyltrimethoxysilane.

8. The method of claim 1, comprising forming a gel on the glass substrate by drying the coating sol formulation coated on the glass substrate prior to annealing the coated glass substrate.

9. The method of claim 1, wherein silica based nanoparticles in the coating sol formulation have a shape selected from spherical, elongated, disc-shaped, and combinations thereof.

10. The method of claim 1, wherein silica based nanoparticles in the coating sol are selected from spherical particles having a particle size from about 40 to 50 nm, spherical particles having a particle size from about 70 to 100 nm, spherical particles having a particle size from about 10 to 15 nm, spherical particles having a particle size from about 17 to 23 nm, elongated particles having a diameter from 9 to 15 nm and length of 40 to 100 nm, and combinations thereof.

11. The method of claim 1, wherein the solvent comprises an alcohol containing solvent, and wherein the coating sol formulation further includes an acid or base containing catalyst.

12. A method according to claim 1, wherein in the coating sol formulation the amount of tetra-alkoxysilane based binder is from about 15-80% (wt. %) of the combination of the tetra-alkoxysilane based binder and the tri-alkoxysilane based binder.

13. A method according to claim 1, wherein in the coating sol formulation the amount of tetra-alkoxysilane based binder is from about 20-70% (wt. %) of the combination of the tetra-alkoxysilane based binder and the tri-alkoxysilane based binder.

14. A method according to claim 1, wherein in the coating sol formulation the amount of tetra-alkoxysilane based binder is from about 40-60% (wt. %) of the combination of the tetra-alkoxysilane based binder and the tri-alkoxysilane based binder.

15. A method according to claim 1, wherein said glass substrate is a matte-matte glass.

16. A method according to claim 1, wherein said glass substrate comprises soda-lime-silica based float glass.

17. A method according to claim 1, wherein said coating step comprises spin coating or dip coating.

18. A method according to claim 1, wherein visible transmittance is increased by at least about 2.8% as a result of said coating being applied and cured on the glass substrate.

19. A method according to claim 1, wherein the thickness of said coating after curing is from about 120 to 140 nm.

20. A method according to claim 1, wherein refractive index of said coating following curing is from about 1.25 to 1.30.

21. A method according to claim 1, wherein said heating comprises heating the coated glass substrate at temperature(s) of at least about 580 degrees C. for at least about 1 minute.

22. The method of claim 1, wherein the coating sol formulation includes water, acetic acid and n-propyl alcohol.

23. The method of claim 1, wherein said aging comprises aging the coating sol formulation at least about three weeks so as to provided the aged coating sol formulation.

24. The method of claim 1, wherein said solvent comprises NPA.

25. The method of claim 1, wherein the tetra-alkoxysilane based binder comprises TEOS.

26. The method of claim 1, wherein the coating is applied directly on the glass substrate.

27. A method of making a coated article including an anti-reflection coating on a substrate, the method comprising:
mixing at least a tri-alkoxysilane based binder with a tetra-alkoxysilane based binder and silica based nanoparticles in forming a wet coating formulation;
aging the wet coating formulation at least about ten days so as to provided an aged wet coating formulation;
coating at least a portion of said aged wet coating formulation onto the glass substrate to form a coating; and
curing the coating.

28. A method of making a coated article including an anti-reflection coating on a substrate, the method comprising:
mixing at least a tri-alkoxysilane based binder and a tetra-alkoxysilane based binder with at least silica based nanoparticles and a solvent in forming a coating sol formulation;
aging the coating sol formulation for a period of time sufficient for both hydrolysis and condensation to occur so as to provide an aged coating sol formulation;
coating at least a portion of said aged coating sol formulation onto the glass substrate to form a coating; and
heating said glass substrate and said coating.

29. The method of claim 28, wherein said aging is for at least ten days.

30. The method of claim 28, wherein said aging is for at least two weeks.

31. The method of claim 28, wherein said aging is at approximately room temperature.
